(19) United States
(12) Patent Application Publication
(10) Pub. No.: US 2019/0018557 A1
(43) Pub. Date: Jan. 17, 2019

(54) SYSTEM AND METHOD FOR STEERING USER INTERACTION IN A MEDIA CONTENT ENVIRONMENT

(71) Applicant: SPOTIFY AB, Stockholm (SE)

(72) Inventors: Brendan O'Driscoll, Dublin (IE); Aidan Sliney, Dublin (IE); Craig Watson, Dublin (IE)

(21) Appl. No.: 15/649,500

(22) Filed: Jul. 13, 2017

(51) Int. Cl. G06F 3/0484; H04L 29/08

(52) U.S. Cl. CPC G06F 3/0484; H04L 67/36; H04L 67/306; H04L 67/22

(57) ABSTRACT

Embodiments of the invention are generally related to systems and methods for steering user interaction in a media content environment. In accordance with an embodiment, data derived from a user's interaction with a media application at a media device is used to determine a category for a user. The data can relate to the user's media consumption habits and preferences. For example, the data can be used to discern a media consumption style or use case, which in turn is used to categorize the user. A personalized user interface (UI) flow can be generated based on the user's determined category. The media device includes an adaptive user interface that implements the UI flow to steer the user's interaction with the media application, for example by drawing the user's attention to features of the media application that are best suited for the user based on the categorization.

### CROSS-REFERENCE TO RELATED APPLICATIONS

This application is related to U.S. patent application titled “SYSTEM AND METHOD FOR PROVIDING TASK-BASED CONFIGURATION FOR USERS OF A MEDIA APPLICATION”, application Ser. No. 15/649,484, filed Jul. 13, 2017; which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to providing digital media content, and to systems and methods for steering user interaction in a media content environment.

### BACKGROUND

User retention is an issue that can affect product and service providers, including those in the media content streaming industry. Low rates of mobile activation by new users during the onboarding process are especially problematic. For example, some media content streaming services experience dropout rates of up to 80% within the first week of registration. Low retention rates are often caused by a lack of understanding of a user's reason for registering with the product or service (e.g., the media application) and how they intend to use it (i.e., the user's intended use case).

### SUMMARY

Embodiments of the invention are generally related to systems and methods for steering user interaction in a media content environment. In accordance with an embodiment, data derived from a user's interaction with a media application at a media device is used to determine a category for a user. The data can relate to the user's media consumption habits and preferences. For example, the data can be used to discern a media consumption style or use case, which in turn is used to categorize the user. A personalized user interface (UI) flow can be generated based on the user's determined category. The media device includes an adaptive user interface that implements the UI flow to steer the user's interaction with the media application, for example by drawing the user's attention to features of the media application that are best suited for the user based on the categorization.

### BRIEF DESCRIPTION OF THE FIGURES

FIG. 1 illustrates an exemplary digital media content environment, in accordance with an embodiment.

FIG. 2 illustrates steering user interaction in a media content environment, in accordance with an embodiment.

FIG. 3 further illustrates steering user interaction in a media content environment, in accordance with an embodiment.

FIG. 4 further illustrates steering user interaction in a media content environment, in accordance with an embodiment.

FIG. 5 further illustrates steering user interaction in a media content environment, in accordance with an embodiment.

FIGS. 6A-6D further illustrate steering user interaction in a media content environment, in accordance with an embodiment.

FIG. 7 further illustrates steering user interaction in a media content environment, in accordance with an embodiment.

FIG. 8 further illustrates steering user interaction in a media content environment, in accordance with an embodiment.

FIG. 9 further illustrates steering user interaction in a media content environment, in accordance with an embodiment.

### DETAILED DESCRIPTION

One approach to personalizing the user experience in a media application is an onboarding process in which new users are asked about their media content tastes when they first sign up. However, this approach is limited in that it does not go beyond surfacing personalized media content for a user. Moreover, this approach does not necessarily improve media content consumption levels or retention rates. A more useful approach is to categorize a user based on her discerned intent in signing up for the media application, including discerning how the user consumes media content.

Embodiments of the invention are generally related to systems and methods for steering user interaction in a media content environment. In accordance with an embodiment, data derived from a user's interaction with a media application at a media device is used to determine a category for a user. The data can relate to the user's media consumption habits and preferences. For example, the data can be used to discern a media consumption style or use case, which in turn is used to categorize the user. A personalized user interface (UI) flow can be generated based on the user's determined category. The media device includes an adaptive user interface that implements the UI flow to steer the user's interaction with the media application, for example by drawing the user's attention to features of the media application that are best suited for the user based on the categorization.

In accordance with an embodiment, a configuration component within a media application environment goes beyond asking a user about their media content tastes (e.g., favorite bands, artists, and genres). Instead, a configuration component according to an embodiment discerns a user's intended use case(s) so that the user's media consumption experience can be adapted in alignment therewith. A user categorization can be based on a discerned media consumption style, a discerned level of intent, and/or particular media application features associated therewith.

According to an aspect of some embodiments, steering user interaction according to a user's categorization can help to align the user experience with the user's expectations regarding a media application, even if a user does not explicitly articulate that expectation.

According to an aspect of some embodiments, users who have developed certain listening habits from one media platform and who are keen to use similar features in a new media platform will have an improved experience at the new media platform. By personalizing the operation of the user interface of a media application to steer user interaction, activation and retention rates can be improved.

### Digital Media Content Environments

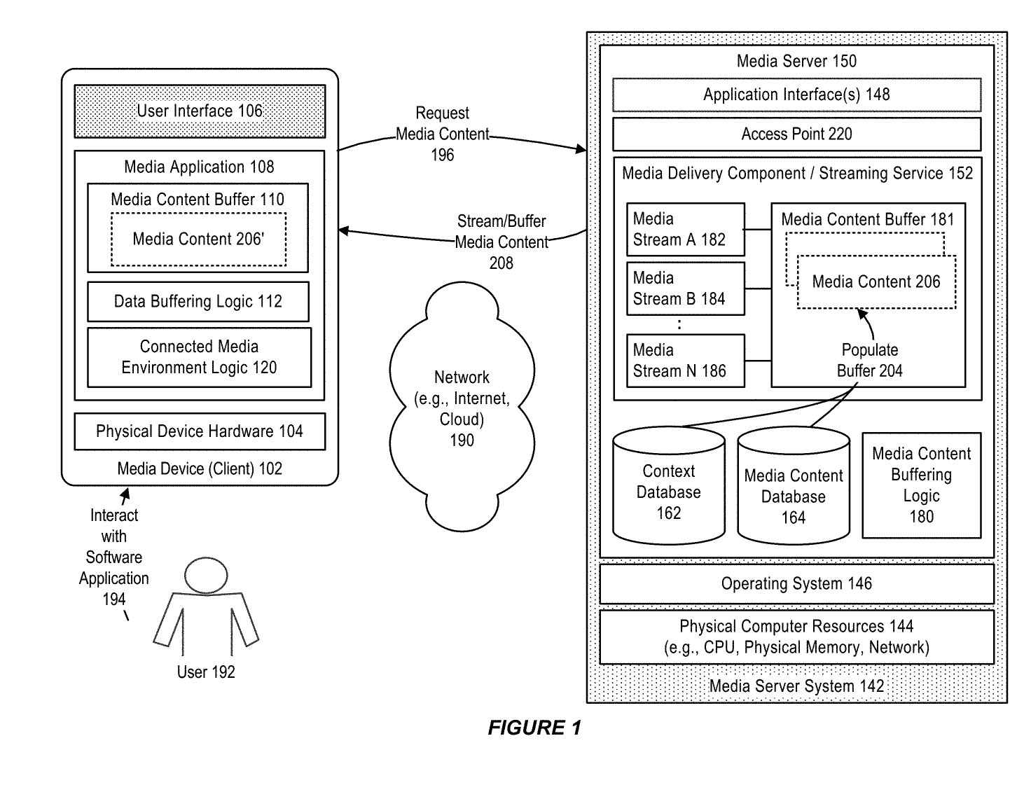

FIG. 1 illustrates an exemplary digital media content environment, in accordance with an embodiment.

As illustrated in FIG. 1, in accordance with an embodiment, a media device 102, operating as a client device, can receive and play media content provided by a media server system 142 (media server), or by another system or peer device. In accordance with an embodiment, the media device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the media device and the media server can include, respectively, one or more physical device or computer hardware resources 104, 144, such as one or more processors (CPU), physical memory, network components, or other types of hardware resources.

Although, for purposes of illustration, a single client media device and media server are shown, in accordance with an embodiment a media server can support the simultaneous use of a plurality of client media devices. Similarly, in accordance with an embodiment, a client media device can access media content provided by a plurality of media servers, or switch between different media streams produced by one or more media servers.

In accordance with an embodiment, the media device can optionally include a touch-enabled or other type of display screen having a user interface 106, which is adapted to display media options, for example as an array of media tiles, thumbnails, or other format, and to determine a user interaction or input. Selecting a particular media option, for example a particular media tile or thumbnail, can be used as a command by a user and/or the media device, to the media server, to download, stream or otherwise access a corresponding particular media content item or stream of media content.

In accordance with an embodiment, the media device can also include a software media application 108, together with an in-memory client-side media content buffer 110, and a client-side data buffering logic or software component 112, which can be provided as software or program code that is executable by a computer system or other processing device, and which can be used to control the playback of media content received from the media server, for playing either at a requesting media device (i.e., controlling device) or at a controlled media device (i.e., controlled device), in the manner of a remote control.

In accordance with an embodiment, a connected media environment logic or software component 120, which can be provided as software or program code that is executable by a computer system or other processing device, can be provided at the media device, either as part of the media application, or separately, for example as a firmware, to enable the media device to participate within a connected media environment (e.g., a Spotify Connect environment) that enables a user to control the playback of media content at such controlled devices.

In accordance with an embodiment, the client-side data buffering logic, together with the media content buffer, enables a portion of media content items, or samples thereof, to be pre-buffered at a client media device. For example, while media options are being prepared for display on a user interface, e.g., as media tiles or thumbnails, their related media content can be pre-buffered at the same time, and cached by one or more media devices in their media content buffers, for prompt and efficient playback when required.

In accordance with an embodiment, the media server can include an operating system 146 or other processing environment which supports execution of a media server 150 that can be used, for example, to stream music, video, or other forms of media content to a client media device, or to a controlled device.

In accordance with an embodiment, the media server can provide a subscription-based media streaming service, for which a client media device or user can have an associated account and credentials, and which enable the user's media device to communicate with and receive content from the media server. A received media-access request from a client media device can include information such as, for example, a network address, which identifies a destination media device to which the media server should stream or otherwise provide media content, in response to processing the media-access request.

For example, a user may own several media devices, such as a smartphone and an audio speaker, which can play media content received from a media server. In accordance with an embodiment, identifying information provided with a media-access request can include an identifier, such as an IP address, MAC address, or device name, which identifies that the media-access request is intended for use with a particular destination device. This allows a user, for example, to use their smartphone as a controlling device, and their audio speaker as a controlled device to which media content should be sent. The media server can then send the requested media and/or forward the media-access request to the audio speaker, even though the request originated at the user's smartphone.

In accordance with an embodiment, one or more application interface(s) 148 can receive requests from client media devices, or from other systems, to retrieve media content from the media server. A context database 162 can store data associated with the presentation of media content by a client media device, including, for example, a current position within a media stream that is being presented by the media device, or a playlist associated with the media stream, or one or more previously-indicated user playback preferences. The media server can transmit context information associated with a media stream to a media device that is presenting that stream, so that the context information can be used by the device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state which is then synchronized with other devices as needed.

For example, in accordance with an embodiment, when the destination media device to which the media content is being streamed changes, say from a controlling device to a controlled device, or from a first controlled device to a second controlled device, then the media server can transmit context information associated with an active media content to the newly-appointed destination device, for use by that device in playing the media content.

In accordance with an embodiment, a media content database 164 can include media content, for example music, songs, videos, movies, or other media content, together with metadata describing that media content. The metadata can be used to enable users and client media devices to search within repositories of media content, to locate particular media content items.

In accordance with an embodiment, a server-side media content buffering logic or software component 180, which can be provided as software or program code that is executable by a computer system or other processing device, can be used to retrieve or otherwise access media content items, in response to requests from client media devices or other systems, and to populate a server-side media content buffer 181, at a media delivery component or streaming service 152, which can be similarly provided as software or program code that is executable by a computer system or other processing device, with streams 182, 184, 186 of corresponding media content data, which can then be returned to the requesting device or to a controlled device.

In accordance with an embodiment, a plurality of client media devices, media server systems, and/or controlled devices, can communicate with one another using a network, for example the Internet 190, a local area network, peer-to-peer connection, wireless or cellular network, or other form of network. For example, a user 192 can interact 194 with the user interface at a client media device, and issue requests to access media content, for example the playing of a selected music or video item at their device, or at a controlled device, or the streaming of a media channel or video stream to their device, or to a controlled device.

In accordance with an embodiment, the user's selection of a particular media option can be communicated 196 to the media server, via the server's application interface. The media server can populate its server-side media content buffer at the server 204, with corresponding media content, 206 including one or more streams of media content data, and can then communicate 208 the selected media content to the user's media device, or to a controlled device as appropriate, where it can be buffered in a client-side media content buffer for playing at the device.

In accordance with an embodiment, and as further described below, the system can include a server-side media gateway or access point 220, provided as software or program code that is executable by a computer system or other processing device, or other process or component, which operates as a load balancer in providing access to one or more servers, for use in processing requests at those servers. The system can enable communication between a client media device and a server, via an access point at the server, and optionally the use of one or more routers, to allow requests from the client media device to be processed either at that server and/or at other servers.

For example, in a Spotify media content environment, Spotify clients operating on media devices can connect to various Spotify back-end processes via a Spotify “accesspoint”, which forwards client requests to other servers, such as sending one or more metadataproxy requests to one of several metadataproxy machines, on behalf of the client or end user.

### Steering User Interaction in a Media Content Environment

In accordance with an embodiment, data derived from a user's interaction with a media application at a media device is used to determine a category for a user. The data can relate to the user's media consumption habits and preferences. For example, the data can be used to discern a media consumption style or use case, which in turn is used to categorize the user. A personalized user interface (UI) flow can be generated based on the user's determined category. The media device includes an adaptive user interface that implements the UI flow to steer the user's interaction with the media application, for example by drawing the user's attention to features of the media application that are best suited for the user based on the categorization.

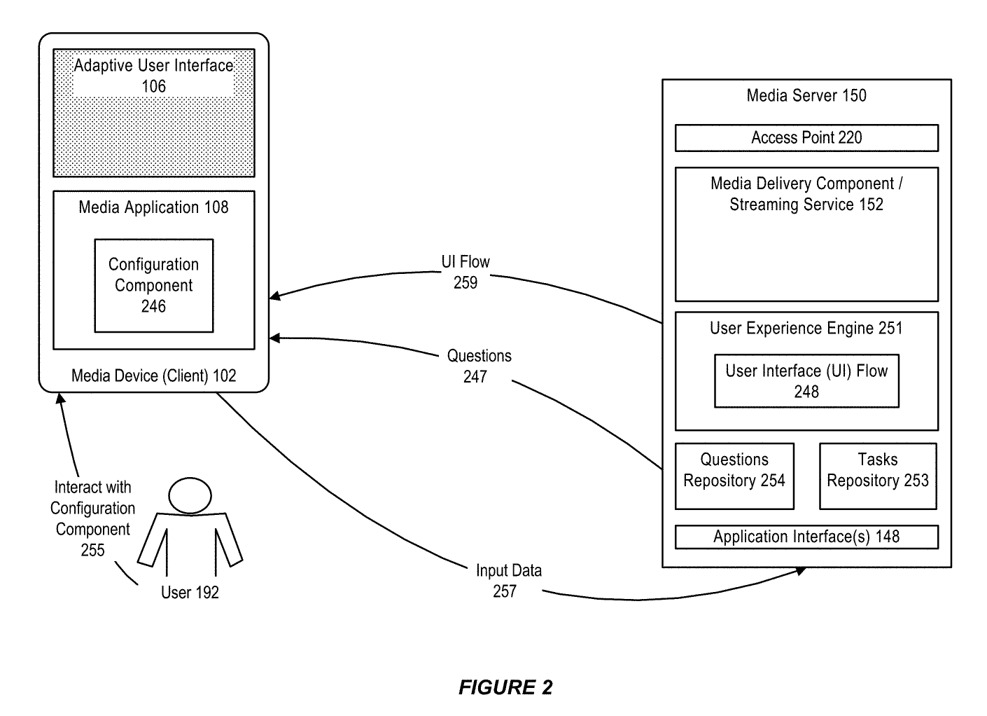

FIG. 2 illustrates steering user interaction in a media content environment, in accordance with an embodiment.

As illustrated in FIG. 2, in accordance with an embodiment, a configuration component 246 is provided as part of a media application 108 on a media device 102.

The media device 102 is configured to provide the configuration component to the user at the adaptive user interface 106. In accordance with an embodiment, the configuration component enables a user to interact with the media application at the media device client, to provide input data. In an embodiment, the configuration component 246 is configured to present questions (e.g., data representing questions) to the user, and to receive the user's responses to the questions. The configuration component can prompt the user to answer questions, based on certain trigger points such as a new user signup, an elapsed time period (e.g., an activation window time period), a change in a level of user interaction with the media application (either an increase or decrease), a detected time frame, a detected user activity, and the like. The configuration component can also be invoked by the user at any time when the media application is open.

The adaptive user interface 106 of the media device 102 enables a user to interact with the configuration component. For example, in an embodiment, the user interface displays questions using a sequence of display screens or menus, and the media device can detect one or more user inputs at the user interface corresponding to options on the display screens or menus (e.g., an icon for “Yes” and an icon for “No”). For example, the media device can detect a press gesture, a tap gesture, or a hover gesture as the user input. The media device can also interpret a user input corresponding to an option on a display screen or menu as an indication of the user's selection of the option.

In accordance with an embodiment, the system is configured to select questions 247 to display at the media device through the configuration component.

For example, in accordance with an embodiment, the logic for selecting and displaying questions at the user interface of the media device can be coded into the media application 108 at the media device. As another example, the media server can be configured to select the questions 247 and to transmit or otherwise communicate data that represents the questions 247 to the configuration component of the media application on the media device. In accordance with an embodiment, the media device 102 is configured to transmit 257 or otherwise communicate the user's responses to the media server as input data.

In accordance with an embodiment, the system can include a questions repository 254 from which questions are selected. The questions repository can include both seed questions and other questions (e.g., follow-up questions). In accordance with an embodiment, the seed questions include a set of basic questions relating to different media application features. For example, a seed question can ask whether the user likes to listen to music from a playlist. Seed questions can be selected at random or can be selected for a user based on the user's behavior (or user history).

In accordance with an embodiment, the system can monitor the user's level of interaction with the media application. For example, a user's profile might indicate that the user has been categorized as a Low Intent User. The system can monitor the user's activity and can detect a change in the level of activity (or level of user interaction with the media application), such as an increase in the amount of activity. In response to detecting the change, the media application can prompt the user to opt-in to receiving questions, to provide input data. The system can select a seed question that is associated with a higher intent user category, such as a Medium or High Intent User category. For example, the selected seed question can ask whether the user would like to create a playlist. In accordance with an embodiment, the input data derived from the user's responses can act as derived signals that are quantified, analyzed, or otherwise used to determine a categorization (e.g., an updated categorization) of the user.

After a seed question has been selected, subsequent follow-up questions can be selected that are targeted toward determining a user's category relative to a current level of intent. The additional input data derived from the user's interaction with the seed question and subsequent follow-up questions can lead to a determination that the user is now in a Medium Intent User category or High Intent User category. As such, the system can generate an updated UI flow based on the additional input data, and the media device can adapt the user interface according to the updated UI flow.

In accordance with an embodiment, subsequent follow-up questions are selected and displayed based on a decision tree (or decision tree logic) for determining a user's category. According to an embodiment, the type of questions selected can depend on the amount of user response received. For example, as more user responses are received, the system can select more granular questions that can be used to determine the user's media consumption style in relation to specific media application features. An additional dimension of categorization can therefore be added that further describes the user's discerned media consumption style or level of intent relative to particular features of the media application.

In accordance with an embodiment, the user interface can also display tasks, and an indication of a media application functionality, such as, for example, access to a personalized playlist or set of media content, offered as an incentive or reward for completion of tasks, as described, for example, in co-pending U.S. patent application titled “SYSTEM AND METHOD FOR PROVIDING TASK-BASED CONFIGURATION FOR USERS OF A MEDIA APPLICATION”, application Ser. No. 15/649,484, filed Jul. 13, 2017, the entirety of which application is herein incorporated by reference.

In accordance with an embodiment, the system includes a tasks repository 253 from which tasks are selected. The system can assign a priority to each task within the tasks repository 253. For example, the system can assign a higher priority to tasks that are associated with the user's determined categorization (e.g., level of intent). In selecting tasks to provide for a particular set of tasks, the system can select tasks based on their assigned priorities.

In accordance with an embodiment, the system can also select tasks from the tasks repository 253 according to an output from the decision tree. In an embodiment, the output identifies top tasks (e.g., the top three tasks) for the user, based on the user's categorization. For example, the system can assign a higher priority to those tasks.

In accordance with an embodiment, the media device can display the selected tasks at the user interface, together with an indication of a media application functionality offered as an incentive or reward for completion of the tasks. In an embodiment, the media application functionality can relate to providing a user with a personalized playlist of media content, and the media content can be provided to the user in a manner that is suitable for her based on her categorization. For example, for a user whose categorization includes the use of playlists, the media application can provide the personalized media content to the user via a playlist.

In accordance with an embodiment, the system includes a user experience engine 251 that determines a UI flow 248. The UI flow 248 is presented dynamically at the adaptive user interface 106 to steer a user's interaction with the media application.

In accordance with an embodiment, the UI flow changes in accordance with the user's categorization. In an embodiment, the UI flow includes a sequence of introductory steps and/or changes to the user interface that emphasize particular media application features associated with the user's categorization. The UI flow can also de-emphasize features of the media application that are less likely to be used by the user, based on the user's categorization. The UI flow therefore focuses the user's attention on those features that increase the media application's usability for the user. The UI flow can include, for example, instructional overlays and coach marks.

In accordance with an embodiment, the system implements the UI flow at the media device. For example, in accordance with an embodiment, the logic for implementing the UI flow can be coded into the media application 108 at the media device. As another example, the media server can determine the UI flow and can transmit 259 or otherwise communicate an instruction to the media device to trigger implementation of the UI flow. The UI flow can be implemented and adapted in real time. In accordance with an embodiment, the system can instruct the media device to render display screens (e.g., instructional overlays or coach marks) illustrating steps of the UI flow and/or to adapt the adaptive user interface according to the UI flow.

In accordance with an embodiment, the media server can also include a user profile engine to build up a user profile for a user and to update (e.g., periodically update) the user profile based on input data received by the media server and categorization data related to media consumption style, discerned intent level, and associated media application features.

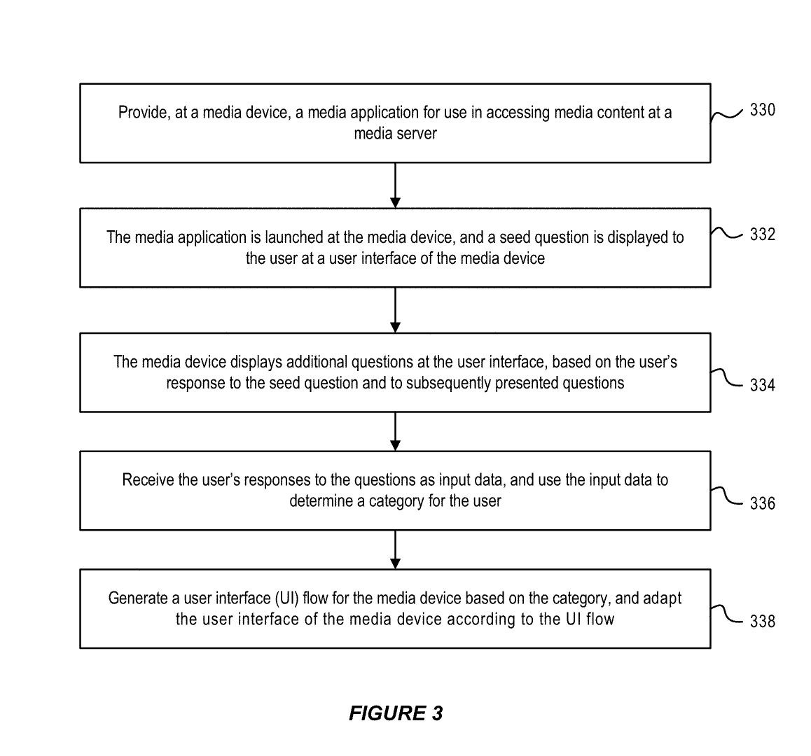

FIG. 3 further illustrates steering user interaction in a media content environment, in accordance with an embodiment.

As illustrated in FIG. 3, in accordance with an embodiment, at operation 330, a media application is provided at a media device for use in accessing media content at a media server.

At operation 332, the media application is launched at the media device, and a seed question is displayed to the user at a user interface of the media device.

At operation 334, the media device displays additional questions at the user interface, based on the user's response to the seed question and to subsequently presented questions.

At operation 336, the user's responses to the questions are received as input data and used to determine a category for the user.

At operation 338, a UI flow is generated for the media device based on the category and the user interface of the media device is adapted according to the UI flow.

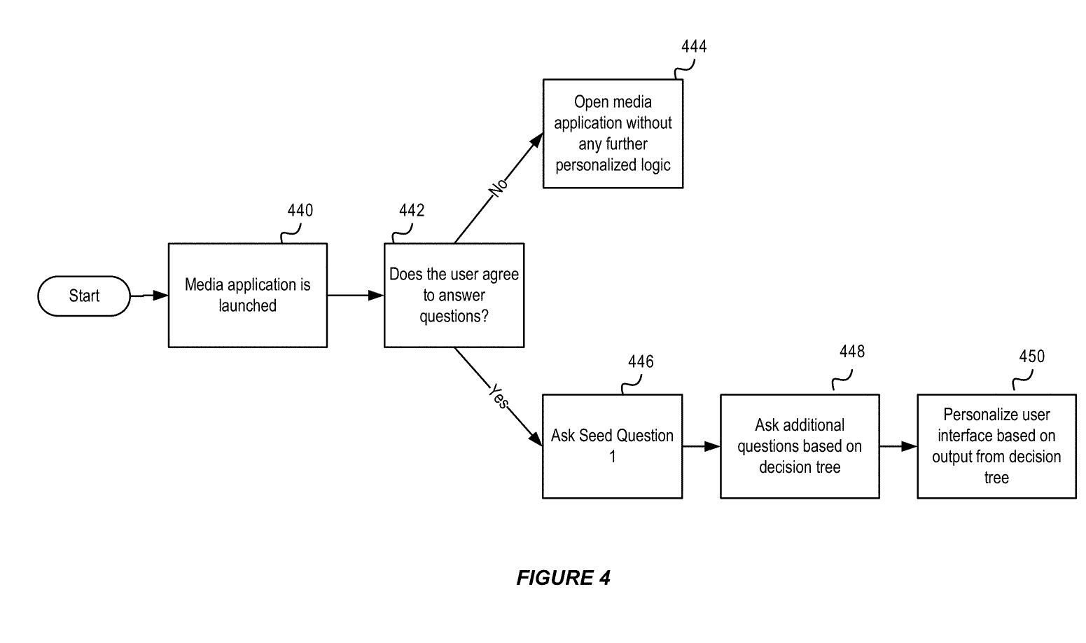

FIG. 4 further illustrates steering user interaction in a media content environment, in accordance with an embodiment.

In accordance with an embodiment, at operation 440, a media application is launched at a media device. At operation 442, the media application (e.g., a configuration component of the media application) determines whether the user agrees to answer questions about the user's media consumption style. If the user provides a negative response, at operation 444 the media application is opened without any further personalized logic. If the user provides an affirmative response, at operation 446 the media application asks a first seed question. At operation 448, the media application asks additional questions based on a decision tree. At operation 450, the media application personalizes a user interface based on an output from the decision tree.

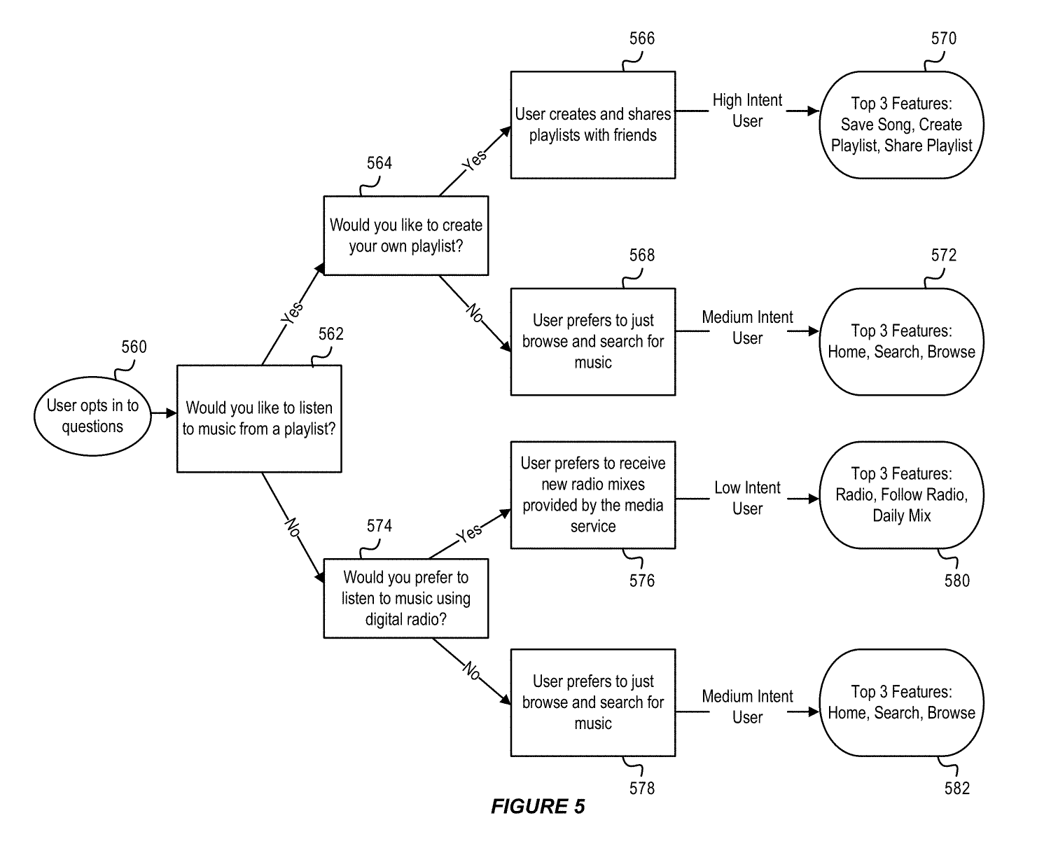

FIG. 5 further illustrates steering user interaction in a media content environment, in accordance with an embodiment.

FIG. 5 depicts an example decision tree according to an embodiment. In accordance with an embodiment, the decision tree is initiated at operation 560 when a user opts-in to receiving questions (e.g., via the configuration component). According to an embodiment, in response to receiving the user's opt-in, the system selects a first seed question 562 to present to the user via the configuration component, for example asking whether the user would like to listen to music from a playlist.

In accordance with an embodiment, if the user provides a “Yes” response to the seed question, then a second/next question 564 can be presented, asking whether the user would like to create their own playlist. Based either on subsequent activity by the user, such as, at operation 566, the user creating and sharing playlists with friends, and/or responding to one or more additional questions, the user is categorized as a “High Intent User.” Based on this determination, at operation 570, the decision tree outputs the top three media application features for the user. In accordance with an embodiment, the output can include features of the media application that are associated with the user's category. In this example, the decision tree outputs the top three media application features as “Save Song,” “Create Playlist,” and “Share Playlist.”

In accordance with an embodiment, if the user provides a “No” response to question 564, indicating that the user does not wish to create her own playlist, then, based either on subsequent activity by the user, such as, at operation 568, the user preferring to just browse and search for music, and/or responding to one or more additional questions, the user is categorized as a “Medium Intent User.” Based on this determination, at operation 572, the decision tree outputs the top three media application features for the user as “Home,” “Search,” and “Browse.”

Returning again to the above example and question 562, if the user provides a “No” response to this seed question, indicating that the user does not wish to listen to music from a playlist, then a different second/next question 574 is presented asking whether the user would prefer to listen to music using digital radio. If the user provides a “Yes” response to question 574, then, based either on subsequent activity by the user, such as, at operation 576, the user preferring to receive new radio mixes provided by the media service and/or responding to one or more additional questions, the user is categorized as a “Low Intent User.” Based on this determination, at operation 580, the decision tree outputs the top three media application features for the user as “Radio,” “Follow Radio,” and “Daily Mix.”

In accordance with an embodiment, if the user provides a “No” response to question 574, indicating that the user does not prefer to listen to music using digital radio, then, based either on subsequent activity by the user, such as, at operation 578, the user preferring to just browse and search for music, and/or responding to one or more additional questions, the user is categorized as a “Medium Intent User.” Based on this determination, at operation 582, the decision tree outputs the top three media application features for the user as “Home,” “Search,” and “Browse.”

In accordance with an embodiment, the decision tree logic can relate some questions to other questions and to different media consumption styles and/or intent levels. In an embodiment, each path within the decision tree includes a plurality of questions designed to test whether a particular user is more or less likely to fit within a certain categorization.

For example, in accordance with an embodiment, a first path (562, 564, 566) corresponds to a first media consumption style (e.g., playlist) and a first level of intent (e.g., high intent level). If an affirmative response is received for question 562, the system determines that the user is likely to have a playlist media consumption style, which is associated with a High Intent User categorization. If an affirmative response is received from the user for question 564, the system determines that the user is more likely to fit within a High Intent User categorization. If additional confirmatory activity or responses are determined at operation 566, the system determines that the user is even more likely to fit within a High Intent User categorization.

In accordance with an embodiment, a second path (562, 574, 576) corresponds to a second media consumption style (e.g., digital radio) and a second level of intent (e.g., low intent level). The second path is an alternative path to the first path. That is, the decision tree logic traverses the second path instead of the first path when the user provides a negative response to question 562. A negative response to question 562 indicates that the user is less likely to have a playlist media consumption style and more likely to fit within a digital radio media consumption style, which is associated with a Low Intent User categorization. If additional confirmatory activity or responses are determined at operation 576, the system determines that the user is even more likely to fit within a Low User Intent categorization.

In accordance with an embodiment, a third path (562, 564, 568) corresponds to a third media consumption style (e.g., browse and search) and a third level of intent (e.g., medium intent level). The third path is an alternative to the first path. That is, the decision tree logic traverses the third path instead of the first path when the user provides a negative response to question 564. A negative response to question 564 indicates that the user is less likely to fit within a High Intent User categorization and more likely to fit within a Medium Intent User categorization. If additional confirmatory activity or responses are determined at operation 568, the system determines that the user is even more likely to fit within the Medium Intent User categorization.

In accordance with an embodiment, a fourth path (562, 574, 578) corresponds to the third media consumption style (e.g., browse and search) and a third level of intent (e.g., medium intent level). The fourth path is an alternative to the second path. That is, the decision tree logic traverses the fourth path instead of the second path when the user provides a negative response to question 574. A negative response to question 574 indicates that the user is less likely to fit within a Low Intent User categorization and more likely to fit within a Medium Intent User categorization. If additional confirmatory activity or responses are determined at operation 578, the system determines that the user is even more likely to fit within the Medium Intent User categorization.

In accordance with an embodiment, although the above examples illustrate how a decision tree can be used in combination with one or more questions and/or determinations of various activities by the user, to determine an end state for a particular user (e.g., as High Intent, or Medium Intent); in accordance with other examples, additional intermediate questions and/or determinations of activities can be used, to assist in determining the end state.

In accordance with an embodiment, questions to be presented to an existing user can be selected based on the user's profile and history. For example, a user's history might indicate that the user often consumes media content via a digital radio feature of the media application. As such, the decision tree logic can specify that the first seed question to be presented relates to the digital radio media consumption style. For example, in an embodiment, the first seed question can ask the user, “Would you like to listen to music using digital radio?” If the user provides an affirmative response, subsequent follow-up questions can be selected that relate to more granular categorizations (e.g., the user prefers to receive new radio mixes daily).

In accordance with an embodiment, a user in a High Intent User category has a media consumption style that is more interactive than a user with a lower intent. As such, a user with a higher level of intent is likely to expend more time and effort in interacting with the media application than a lower intent user. Media application features selected for a High Intent User involve a higher degree (or level) of user interaction, in that the user plays a more active role in selecting the media content that she consumes. For example, in an embodiment, the media application features “Save Song,” “Create Playlist,” and “Share Playlist” all involve user action in selecting media content.

In accordance with an embodiment, a user in a Low Intent User category has a media consumption style that is more passive than interactive. Such a user is likely to expend less time and effort in interacting with the media application than a higher intent user. Media application features selected for a Low Intent User involve more passive media consumption, in that the media content is selected for the user rather than the user playing an active role in selecting content. For example, in an embodiment, the media application features “Radio,” “Follow Radio,” and “Daily Mix” involve the media application automatically curating media content for the user.

In accordance with an embodiment, a user in a Medium Intent User category is in between a High Intent User and a Low Intent User in terms of the amount of interactivity they wish to have with the media application. For example, in an embodiment, the media application features “Home,” “Search,” and “Browse” involve some user action in selecting media content, but also involve the media application selecting media content for the user.

In accordance with an embodiment, a user can also be categorized as a Mixed Intent User, which is a media consumption style that involves a combination of High Intent User and Low Intent User behavior. For example, a Mixed Intent User might exhibit a higher intent level with respect to some features of a media application (e.g., sharing media content with friends), but might exhibit a lower intent level with respect to other features (e.g., the user might prefer digital radio). A Mixed Intent User might also exhibit different levels of intent depending on context, as described below.

In accordance with an embodiment, after a user's category has been determined, new questions can be selected that are configured to further categorize the user. For example, for a High Intent User, new questions can be selected that can be used to determine sub-categories for the user. In accordance with an embodiment, the resulting input data can be used to further identify what type of High Intent User the individual is, such as a High Intent User who shares media content with friends, or a High Intent User who creates playlists, or a High Intent User who listens to podcasts.

In accordance with an embodiment, the decision tree logic can be stored in the media server, and the media server can transmit instructions to the client media device for rendering the questions at the user interface of the media device. However, embodiments are not limited thereto, and the decision tree logic can be coded in the media application at the client media device.

In accordance with an embodiment, the structure of the decision tree can be predetermined and stored as part of the decision tree logic, or the structure of the decision tree can be dynamically built as input data is received from a user.

Although the above functionality is described in relation to a decision tree, embodiments are not limited thereto, and the same or similar functionality can be provided using any suitable logic or component.

A configuration component according to an embodiment can be used to steer interaction of both new users and existing (i.e., non-new) users. That is, in accordance with an embodiment, the configuration component can be utilized at any point in a user's life cycle.

In accordance with an embodiment, for new users, delivering a personalized user experience can improve retention rates. In such cases, a media application might have only preliminary information about the user (e.g., demographic data such as age, gender, and location). However, this basic data is insufficient for the media application to discern the user's intended use case(s) in order to categorize the user and provide a personalized user experience.

In one example, User A and User B are both female users located in Stockholm, Sweden. User A prefers listening to digital radio and therefore intends to use the media application to have a passive listening experience. User B, on the other hand, prefers curating her own content and therefore intends to use the media application to create playlists for consuming music. However, because both users are new to the media application, the media application does not have a way to differentiate the two users. As a result, in a conventional media application environment, both users receive a substantially similar experience despite their very different intended use cases. This can lead to the users failing to discover the media application features or content that best suit the way in which they wish to consume media content. A system and method for steering user interaction in a media content environment addresses this issue by tuning the media application environment to each user's intended use case(s).

In accordance with an embodiment, for existing users, a configuration component can be periodically updated with new and/or different questions as the user's life cycle progresses, in accordance with any changes in the user's categorization. Thus, the configuration component can provided on an ongoing basis, and the user interface can be continually adapted to suit the user's intended use cases. As a result, the configuration component can have longer term adaptability than a traditional set-up wizard or typical taste onboarding approaches.

In accordance with an embodiment, a user's categorization can depend on contextual factors such as the user's environment, media device type, day of week, time of day, and the like. The system can receive and analyze contextual signals containing this data, and use the contextual signals to further discern a user's intended use case(s). An approach to analyzing context data to determine user activities is described, for example, in co-pending U.S. patent application titled “APPARATUS FOR RECOGNISING AND INDEXING CONTEXT SIGNALS ON A MOBILE DEVICE IN ORDER TO GENERATE CONTEXTUAL PLAYLISTS AND CONTROL PLAYBACK,” application Ser. No. 15/087,428, filed Mar. 31, 2016, which claims the benefit of priority to U.S. provisional patent application titled “APPARATUS FOR RECOGNISING AND INDEXING CONTEXT SIGNALS ON A MOBILE DEVICE IN ORDER TO GENERATE CONTEXTUAL PLAYLISTS AND CONTROL PLAYBACK”, Application No. 62/141,414, filed Apr. 1, 2015; the entirety of which applications are herein incorporated by reference.

For instance, a user's profile can indicate that on Mondays, the user consumes media content from 7:00 A.M. to 7:30 A.M., on the user's mobile device, while jogging. During this activity and time frame, the user's history indicates that the user consumes media content through a digital radio feature. The system therefore associates a category of low intent level with the user during this activity and time frame. As such, the system can generate a UI flow for the user that emphasizes features according to the user's categorization, such as the digital radio feature. The system instructs the media device to provide the UI flow during the specified time frame and activity.

Accordingly, the system can generate a plurality of different UI flows for a user based on context data, and the adaptive user interface of the media device can be adapted to implement the different UI flows in accordance with the context.

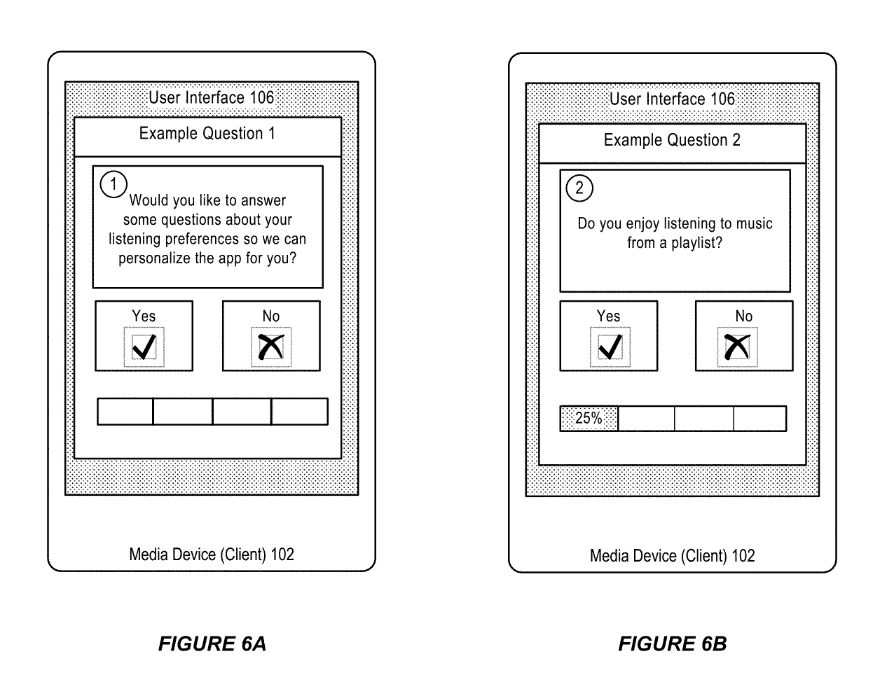

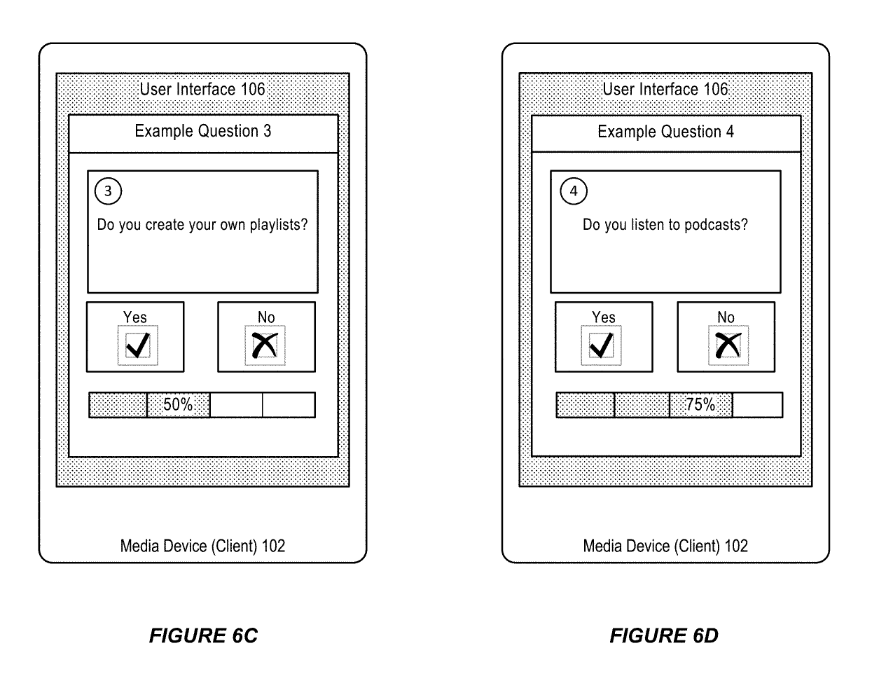

FIGS. 6A-6D further illustrate steering user interaction in a media content environment, in accordance with an embodiment.

FIG. 6A depicts a first display screen of a configuration component provided at a user interface 106 of a media device 102. As illustrated in FIG. 6A, when the media application is launched at a media device, the configuration component presents an opt-in question to the user. The opt-in question asks, “Would you like to answer some questions about your listening preferences so we can personalize the app for you?” An icon for a “Yes” response and an icon for a “No” response are provided at the user interface. The configuration component can also include a progress bar for visually indicating the proportion of questions completed by the user.

FIG. 6B depicts a second display screen of a configuration component provided at a user interface 106 of a media device 102. In accordance with an embodiment, in response to receiving an affirmative response to the opt-in question depicted in FIG. 6A, the configuration component follows up with a seed question. The seed question asks, “Do you enjoy listening to music from a playlist?” An icon for a “Yes” response and an icon for a “No” response are provided at the user interface. The progress bar indicates that 25% of the questions have been completed.

FIG. 6C depicts a third display screen of a configuration component provided at a user interface 106 of a media device 102. In accordance with an embodiment, in response to an affirmative response to the seed question depicted in FIG. 6B, the configuration component follows up with an additional question that is related to the playlist media consumption style. An affirmative response to this question indicates that the user is likely to be in a High Intent User category. The additional question asks, “Do you create your own playlists?” An icon for a “Yes” response and an icon for a “No” response are provided at the user interface. The progress bar indicates that 50% of the questions have been completed.

FIG. 6D depicts a fourth display screen of a configuration component provided at a user interface 106 of a media device 102. In accordance with an embodiment, in response to receiving an affirmative response to the question depicted in FIG. 6C, the configuration component follows up with an additional question. An affirmative response to this question indicates that the user is even more likely to be in a High Intent User category. In FIG. 6D, the additional question asks, “Do you listen to podcasts?” An icon for a “Yes” response and an icon for a “No” response are provided at the user interface. The progress bar indicates that 75% of the questions have been completed.

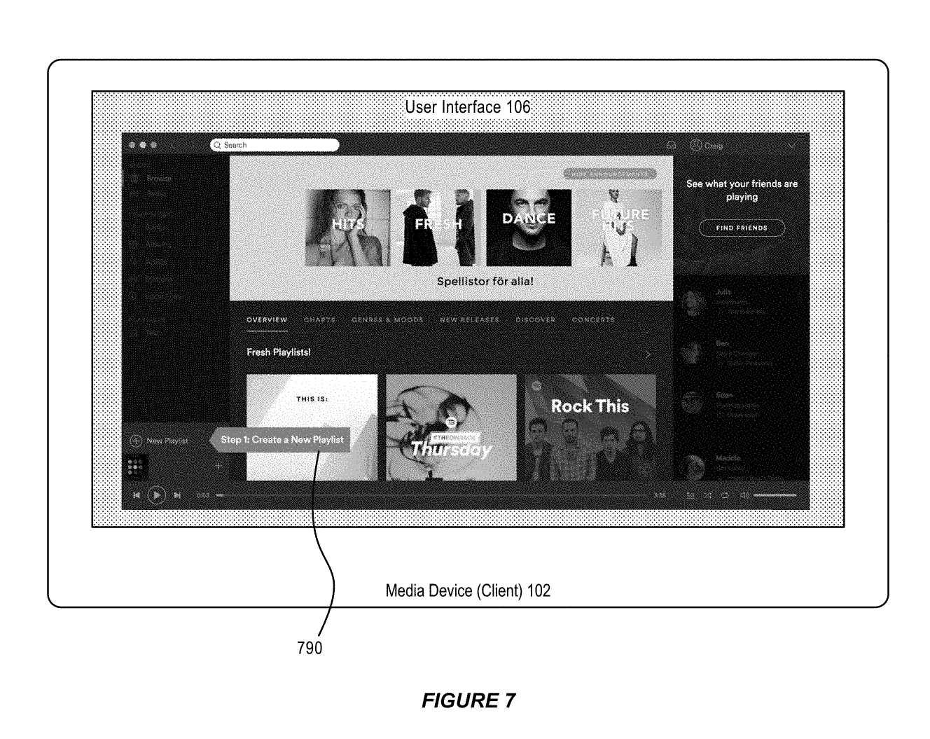

FIGS. 7-9 further illustrate steering user interaction in a media content environment, in accordance with an embodiment.

FIGS. 7-9 depict display screens of an adaptive user interface in accordance with an embodiment. In the depicted embodiment, a UI flow has been generated based on a categorization of a user as a High Intent User who creates and share playlists. The UI flow is configured to steer the user toward features of the media application suitable for a High Intent User, including creating a playlist, finding some friends, and sending the playlist to the friends. In the examples depicted in FIGS. 7-9, the UI flow includes a sequence of introductory steps and changes to the user interface.

As depicted in FIG. 7, the first step in the UI flow is “Create a New Playlist.” An interactive pop up icon 790 in the shape of an arrow is used to show the user where this feature can be found in the menu. Other menu options are visually de-emphasized to focus the user's attention on the appropriate feature. For example, the other menu options are covered by an overlay.

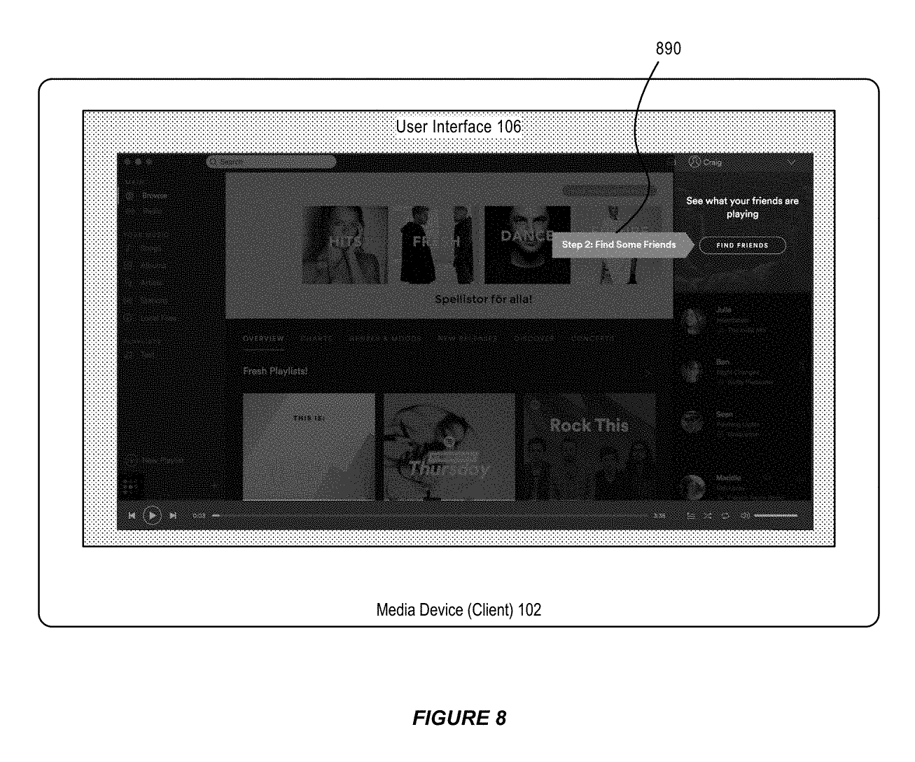

As depicted in FIG. 8, the second step in the UI flow is “Find Some Friends.” An interactive pop up icon 890 in the shape of an arrow is used to show the user where this feature can be found on the display screen. Other display elements are visually de-emphasized to focus the user's attention on the appropriate feature. For example, the other display elements are covered by an overlay.

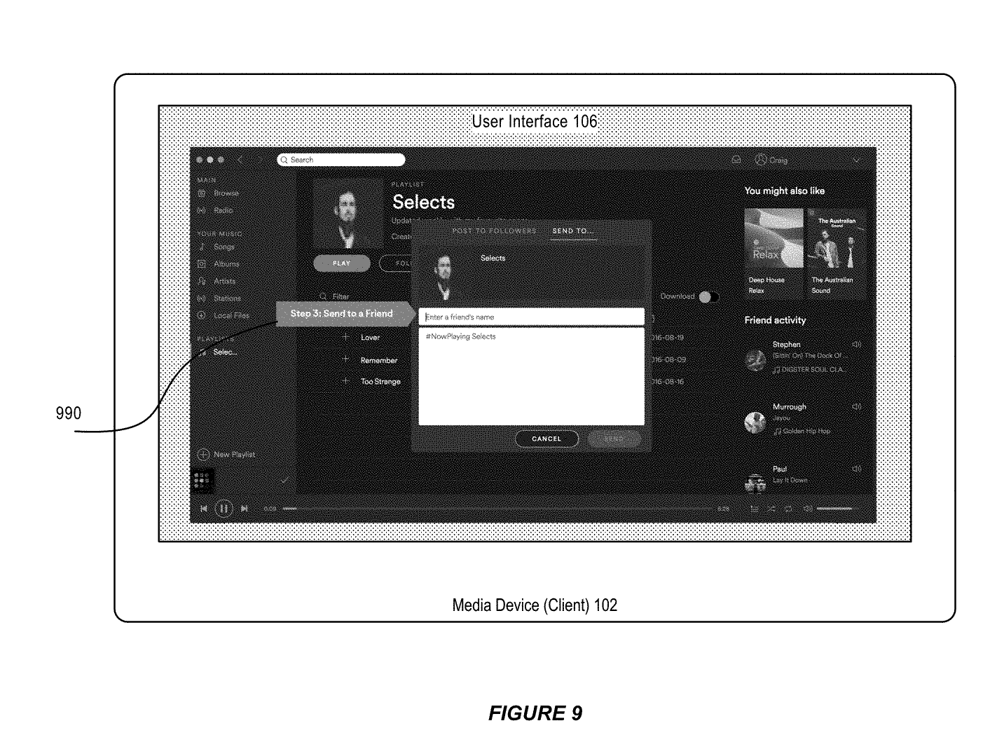

As depicted in FIG. 9, the third step in the UI flow is “Send to a Friend.” An interactive pop up window is brought to the foreground of the display screen and a pop up icon 990 in the shape of an arrow is used to show the user where this feature can be found. Other display elements are visually de-emphasized to focus the user's attention on the appropriate feature. For example, the other display elements remain in the background behind the pop up window and pop up arrow.

Embodiments can be conveniently implemented using one or more conventional general purpose or specialized digital computers, computing devices, machines, or microprocessors, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the system includes a computer program product which is a non-transitory storage medium or computer readable medium (media) having instructions stored thereon/in which can be used to program a computer to perform any of the processes. Examples of the storage medium can include, but are not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of embodiments has been provided for the purposes of illustration and description. It is not intended to be exhaustive or to limit the invention to the precise forms disclosed. Many modifications and variations will be apparent to the practitioner skilled in the art.

For example, while the techniques described above generally illustrate examples such as a music streaming service such as Spotify, and streamed music or song content, the systems and techniques described herein can be similarly used with other types of media content environments, and other types of streamed data or media content.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1. A system for steering user interaction with a media application, the system comprising:
a computer, including a media server executing thereon that is configured to receive requests from media device clients to download, stream or otherwise access a media content item or stream of media content;
a questions repository that stores data that represents questions, for use with a configuration component of a media application at a media device, wherein the media server is configured to:
transmit, to the configuration component of the media application at the media device, data that represents selected questions, for display at a user interface of the media device, and
receive, from the media device, an input data associated with user responses to the selected questions displayed at the user interface of the media device;
wherein subsequent to receipt of a user's input data, the system:
determines a particular category for the user from among a plurality of categories, based on the input data,
wherein a first category of the plurality of categories is associated with a first user interface (UI) flow and a second category of the plurality of categories is associated with a second UI flow, and
upon determination of the particular category for the user, causes the media device to perform steps according to the UI flow associated with the particular category, which UI flow is used by the configuration component to guide adaptation of the media application for use with the media server,
wherein the user interface of the media device client is adapted according to the UI flow.

2. The system of claim 1, wherein the media application is configured to transmit data representing questions about media consumption preferences of the user, to the media application at the media device client.

3. (canceled)

4. The system of claim 2, wherein the data representing the questions is displayed to the user according to a decision tree logic.

5. The system of claim 4, wherein the decision tree logic is configured to output one or more features of the media application associated with the category.

6. The system of claim 5, wherein the UI flow comprises a sequence of steps configured to steer the user toward the one or more features of the media application associated with the category.

7. The system of claim 1, wherein the system is configured to monitor a level of user interaction with the media application.

8. The system of claim 7, wherein in response to detecting a change in the level of user interaction with the media application, the system is configured to prompt the user to interact with the media application to provide additional input data.

9. The system of claim 8, wherein the system is further configured to generate an updated UI flow based on the additional input data, and to adapt the user interface of the media client device according to the updated UI flow.

10. A method of steering user interaction with a media application, the method comprising:
providing, at a computer,
a media server executing thereon that is configured to receive requests from media device clients to download, stream or otherwise access a media content item or stream of media content, and
a questions repository that stores data that represents questions, for use with a configuration component of a media application at a media device, wherein the media server is configured to:
transmit, to the configuration component of the media application at the media device, data that represents selected questions, for display at a user interface of the media device, and
receive, from the media device, an input data associated with user responses to the selected questions displayed at the user interface of the media device; and
subsequent to receipt of a user's input data,
determining a particular category for the user from among a plurality of categories, based on the input data,
wherein a first category of the plurality of categories is associated with a first user interface (UI) flow and a second category of the plurality of categories is associated with a second UI flow, and
upon determination of the particular category for the user, causing the media device to perform steps according to the UI flow associated with the particular category, which UI flow is used by the configuration component to guide adaptation of the media application for use with the media server, and
adapting the user interface of the media device client according to the UI flow.

11. The method of claim 10, further comprising transmitting data representing questions about media consumption preferences of the user, to the media application at the media device client.

12. (canceled)

13. The method of claim 11, wherein the data representing the questions is displayed to the user according to a decision tree logic.

14. The method of claim 13, wherein the decision tree logic is configured to output one or more features of the media application associated with the category.

15. The method of claim 14, wherein the UI flow comprises a sequence of steps configured to steer the user toward the one or more features of the media application associated with the category.

16. The method of claim 10, further comprising monitor a level of user interaction with the media application.

17. The method of claim 16, further comprising, in response to detecting a change in the level of user interaction with the media application, prompting the user to interact with the media application to provide additional input data.

18. The method of claim 17, further comprising generating an updated UI flow based on the additional input data, and adapting the user interface of the media client device according to the updated UI flow.

19. A non-transitory computer readable storage medium, including instructions stored thereon which when read and executed by one or more computers cause the one or more computers to perform the method comprising:
providing, at one or more computers, a media server executing thereon that is configured to receive requests from media device clients to download, stream or otherwise access a media content item or stream of media content, and
a questions repository that stores data that represents questions, for use with a configuration component of a media application at a media device, wherein the media server is configured to:
transmit, to the configuration component of the media application at the media device, data that represents selected questions, for display at a user interface of the media device, and
receive, from the media device, an input data associated with user responses to the selected questions displayed at the user interface of the media device; and
subsequent to receipt of a user's input data,
determining a particular category for the user from among a plurality of categories, based on the input data,
wherein a first category of the plurality of categories is associated with a first user interface (UI) flow and a second category of the plurality of categories is associated with a second UI flow, and
upon determination of the particular category for the user, causing the media device to perform steps according to the UI flow associated with the particular category, which UI flow is used by the configuration component to guide adaptation of the media application for use with the media server,
wherein the user interface of the media device client is adapted according to the UI flow.

20. The system of claim 1, wherein one or more categories of the plurality of categories is associated with a media consumption style of a user.

21. The method of claim 10, wherein one or more categories of the plurality of categories is associated with a media consumption style of a user.
